(19) United States
(12) Patent Application Publication
(10) Pub. No.: US 2008/0173244 A1
(43) Pub. Date: Jul. 24, 2008

(54) ANIMAL FEEDER APPARATUS

(76) Inventors: Daniel Welker, Sugar Land, TX (US); Kyle Welker, Sugar Land, TX (US); Brian H. Welker, Sugar Land, TX (US)

Correspondence Address: HUSCH BLACKWELL SANDERS LLP, 4801 Main Street, Suite 1000, KANSAS CITY, MO, 64112, US

(21) Appl. No.: 11/626,085

(22) Filed: Jan. 23, 2007

(51) Int. Cl. A01K 5/00; B65H 75/48

(52) U.S. Cl. 119/51.01; 242/390

(57) ABSTRACT

An animal feeder apparatus is provided that includes a stand, an animal feeder assembly, an animal feeder suspension assembly, and a vehicle-mounted winch assembly. The animal feeder apparatus has a configuration enabling the animal feeder assembly to be raised and lowered by the vehicle-mounted winch assembly.

### CROSS-REFERENCE TO RELATED APPLICATIONS

None.

### BACKGROUND OF THE INVENTION

Wildlife enthusiasts, photographers, landowners, and hunters have long used feeders to attract and keep animals in a particular area. There are several of these animal feeders available on the marketplace. One of the most popular feeders includes a container permanently mounted to a tripod base having three legs or quadpod base having four legs. The container is often a 30- or 55-gallon drum and is located 8 to 12 feet above the ground, thus making it difficult to fill. The containers can often hold between 200 and 350 pounds of feed.

Known animal feeders require a ladder to be used when filling the container. The user must climb the ladder with bags of feed in order to fill the container from an opening located atop the container. Because the feed usually comes in 50-pound bags, the user is required to make several trips up and down the ladder when filling the container. Carrying these multiple heavy loads up the ladder requires the user to exert extensive physical effort in filling the container. It also puts the user at risk of injury resulting from falling from the ladder, tipping the ladder, or straining him or herself in the process of hauling the multiple heavy loads up the ladder.

Other known feeders utilize a hoist cable and a heavy duty winch to raise and lower the container so that it can be filled. However, in each of these feeders, the winch is permanently attached to the feeder. This requires that each feeder have its own winch which increases the production cost and associated purchase price of each feeder. This also results in each of the winches being left exposed to the weather and elements in the field thereby causing damage, sometimes irreparable, to the winches.

Accordingly, a need exists in the art for an animal feeder apparatus that eliminates the risk of injury due to climbing a ladder with heavy loads of feed. A need further exists for an animal feeder apparatus that is adapted for use with a single winch that can be used on several different feeders thereby lowering the production cost and the ultimate purchase price. Additionally, a need exists for an animal feeder with a means for raising and lowering the container that is resistant to the weather and elements.

### SUMMARY OF THE INVENTION

The present invention is directed to an animal feeder apparatus that includes a stand with at least three legs and a top portion, an animal feeder assembly with a container, at least two support legs, a hanger, and a feed dispensing assembly, an animal feeder suspension assembly with a cable and at least one pulley, and a vehicle-mounted winch assembly. In lieu of a vehicle-mounted winch assembly, the animal feeder apparatus can also include a linear actuator and a vehicle-mounted means for actuating the linear actuator.

The present invention is also directed to an animal feeder apparatus that includes a means for coupling a vehicle-mounted winch assembly to an animal feeder suspension assembly, a means for coupling said animal feeder suspension assembly to an animal feeder assembly, a means for raising and lowering said animal feeder assembly by actuating said vehicle-mounted winch assembly, a means for retaining said animal feeder assembly in a raised position, and a means for dispersing animal feed.

### DESCRIPTION OF THE SEVERAL VIEWS OF THE DRAWINGS

FIG. 1 is a front perspective view of the animal feeder apparatus with the animal feeder assembly in a raised position in accordance with one embodiment of the present invention;

FIG. 2 is a front perspective view of the animal feeder apparatus with the animal feeder assembly in a raised position in accordance with another embodiment of the present invention;

FIG. 3 is a front perspective view of the animal feeder apparatus with the animal feeder assembly in a raised position in accordance with one embodiment of the present invention;

FIG. 4 is a front perspective view of the animal feeder apparatus with the animal feeder assembly in a lowered position in accordance with one embodiment of the present invention; and

FIG. 5 is a front sectional view of the animal feeder apparatus with the animal feeder assembly in a raised position in accordance with one embodiment of the present invention.

### DETAILED DESCRIPTION OF THE INVENTION

The present invention is directed to an animal feeder apparatus 10 that includes a stand 12, an animal feeder assembly 46, and an animal feeder suspension assembly 80.

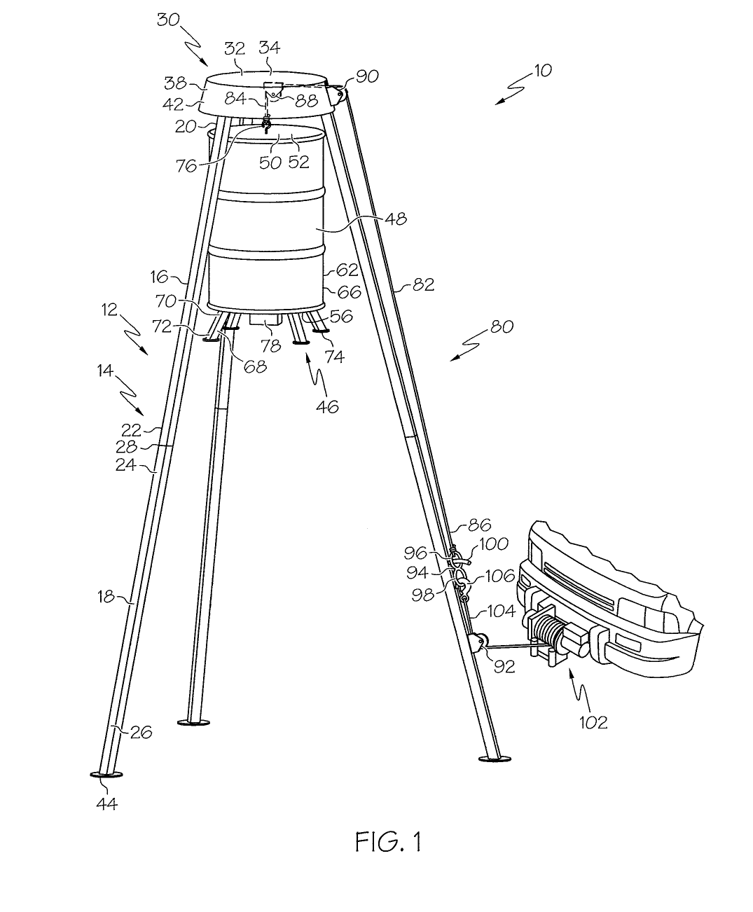

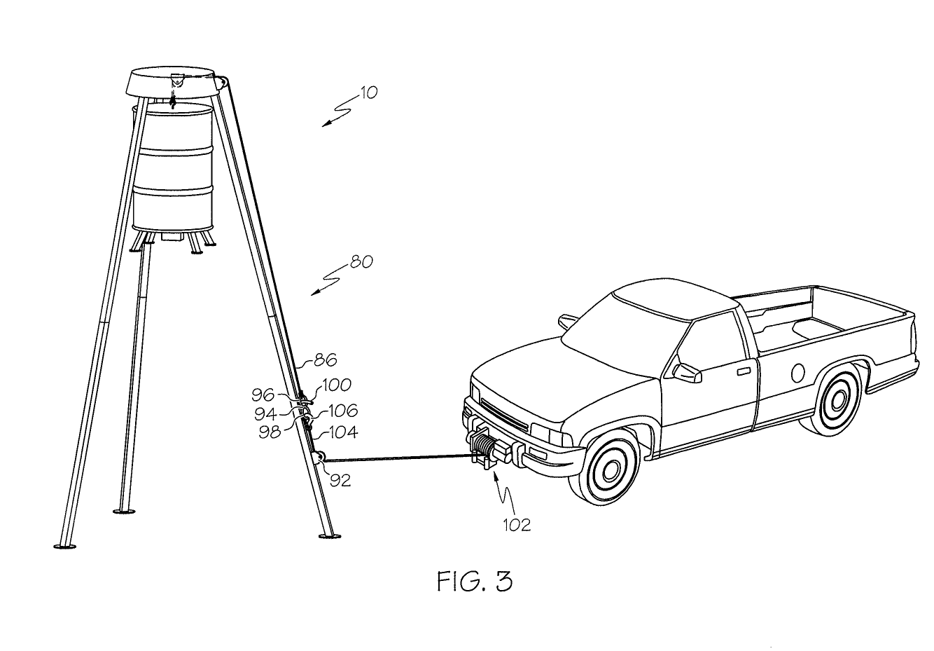

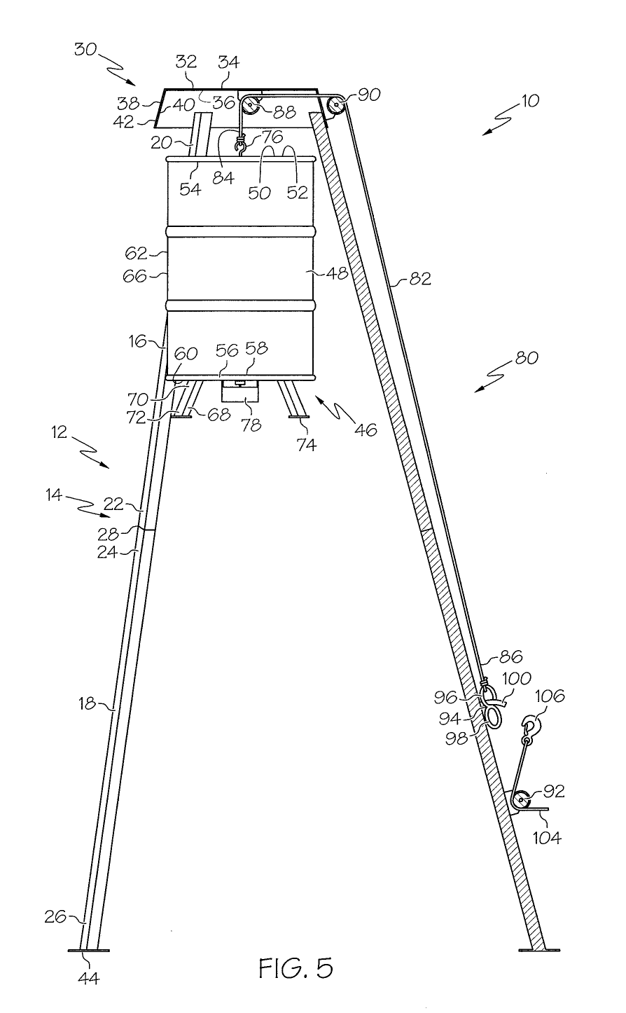

As shown in FIGS. 1-5, the stand 12 includes at least three legs 14 and a top 30. The legs 14 include upper sections 16 having first ends 20 and second ends 22 and lower sections 18 having first ends 24 and second ends 26. The top 30 includes upper portion 32 having a top surface 34 and a bottom surface 36 and a substantially cylindrical flange 38 having an inner surface 40 and an outer surface 42.

The leg upper section first ends 20 are affixed to the top 30. It will be appreciated by one skilled in the art that the leg upper section first ends 20 can be affixed to the top flange inner surface 40 or the top flange outer surface 42. It will also be appreciated that if the leg upper section first ends 20 are affixed to the top flange inner surface 40, they can extend upwardly and also be affixed to the top upper portion bottom surface 36.

The leg upper section second ends 22 and lower section first ends 24 are removably coupled at joints 28 allowing the leg lower sections 18 to be removed for transport and storage. Feet 44 are affixed to the leg lower section second ends 26.

In one embodiment of the present invention, when the leg lower sections 18 are attached to the leg upper sections 16, the total height of the stand 12 is from about 9 to 13 feet, more preferably from about 10 to 12 feet, and most preferably about 11 feet. It will be appreciated by one skilled in the art that the material of the components making up the stand 12 may be selected from the group consisting of metal, fiberglass, carbon fiber, combinations thereof, or any other material suitable for use in the present invention now known or hereafter developed.

As shown in FIGS. 1-5, the animal feeder assembly 46 includes a container 48, at least two container support legs 68, a hanger 76, and a feed dispensing assembly 78. In one embodiment, the container 48 is a 55-gallon drum and holds up to 350 pounds of animal feed. It will be appreciated by one skilled in the art that the container 48 can be of any shape or size suitable for use in the present invention. In one embodiment, the container 48 includes a top portion 50 having a top surface 52 and a bottom surface 54, a bottom portion 56 having a top surface 58 and a bottom surface 60, and a substantially cylindrical sidewall 62 having an inner surface (not shown) and an outer surface 66.

A hanger 76 configured for suspending the container 48 can be affixed to the container 48 at its top portion 50. It will be appreciated by one skilled in the art that the hanger 76 can also be affixed to the container 48 at its sidewall 62 or its bottom portion 56.

The container support legs 68 have first ends 70 and second ends 72. The container support leg first ends 70 are affixed to the container bottom portion bottom surface 60 such that the support legs 68 extend downwardly from the container 48. Feet 74 are affixed to the support leg second ends 72 and are configured to support the container 48 when placed on the ground.

A feed dispensing assembly 78 is mounted to the container bottom portion 56. The feed dispensing assembly 78 is in communication with an opening extending through the container bottom portion 56 and can be chosen from the several feed dispensing assemblies that are commercially available on the market. The feed dispensing assembly 78 is configured to broadcast animal feed in the area surrounding the animal feeder apparatus or drop animal feed in a pile on the ground beneath the apparatus.

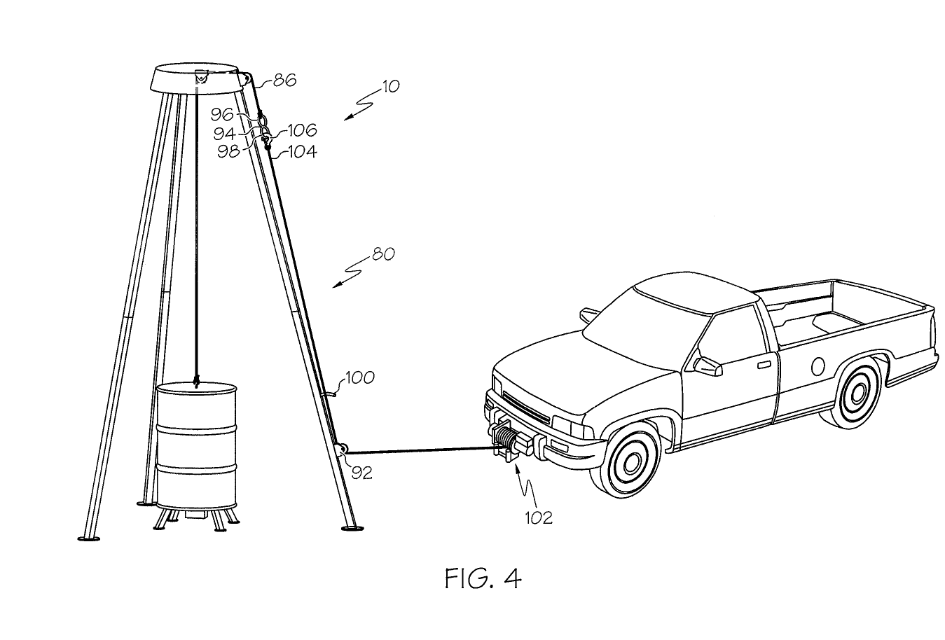

In a preferred embodiment, the container support legs 68 extend downward farther from the container bottom portion bottom surface 60 than the feed dispensing assembly 78 such that the support legs 68, and not the feed dispensing assembly 78, come into contact with the ground surface when the animal feeder assembly is in a lowered position, as shown in FIG. 4.

As shown in FIGS. 1-5, the animal feeder suspension assembly 80 includes a cable 82 having a first end 84 and a second end 86, and at least one pulley 88. It will be appreciated by one skilled in the art that the cable 82 can be replaced with rope, wire, cord, line, or any other flexible material suitable for use in the present invention. The at least one pulley 88 is mounted to the top upper portion 32 of the stand 12.

FIGS. 1, 3, 4, and 5 show an embodiment of the invention wherein a vehicle-mounted winch assembly 102 is utilized to raise and lower the animal feeder assembly 46. As used herein, the term “vehicle” is defined to mean any device for carrying passengers, goods, and/or equipment, usually moving on wheels or runners. Examples of vehicles include, but are not limited to, automobiles, trucks, all-terrain vehicles, tractors, golf carts, and any other vehicles suitable for use in the present invention now known or hereafter developed. In this embodiment, a second pulley 90 is mounted to the stand 12 proximate one of the leg upper section first ends 20 and a third pulley 92 is mounted to one of the leg lower sections 18 between its first end 24 and second end 26. The cable first end 84 is suspended from a pulley 88 and is secured to the hanger 76 that is affixed to the container 48 at its top portion 50.

The embodiment shown in FIGS. 1, 3, 4, and 5 includes a link 94 having a first loop 96 and a second loop 98. This embodiment also includes a dowel 100 that protrudes from one of the leg lower sections 18 between its first end 24 and second end 26. It will be appreciated by one skilled in the art that the dowel 100 can either be permanently affixed to one of the leg lower sections 18 or can be removably attached thereto. The cable second end 86 is secured to the link first loop 96. The link first loop 96 can be placed over the dowel 100 in order to secure the animal feeder assembly 46 in a raised position.

In use, when a user desires to lower the animal feeder assembly 46 so that it can be refilled or maintained, the user extends a cable 104 from the vehicle-mounted winch assembly 102. The user then attaches a hook 106 that is secured to the winch cable 104 to the link second loop 98. Once the hook 106 is attached to the link second loop 98, the winch cable 104 is slightly retracted by the vehicle-mounted winch 102 so that the link first loop 96 can be decoupled from the dowel 100. In one embodiment, wherein the dowel 100 is removably attached to one of the leg lower sections 18, once the winch cable 104 is slightly retracted by the vehicle-mounted winch 102, the dowel 100 may be removed from the leg lower section 18, thus allowing the link first loop 96 to be decoupled from the dowel 100. After the link first loop 96 is decoupled from the dowel 100, the winch cable 104 is released by the vehicle-mounted winch 102 allowing the animal feeder assembly 46 to be lowered to the ground.

Once on the ground, the animal feeder assembly 46 can be refilled and/or maintained. When the user desires to raise the animal feeder assembly 46, the winch cable 104 is retracted by the vehicle-mounted winch 102. If the user desires to return the animal feeder assembly 46 to its raised position, the winch cable 104 is retracted by the vehicle-mounted winch 102 far enough to allow the link first loop 96 to be coupled with the dowel 100. Once the link first loop 96 is coupled to the dowel 100, the hook 106 can be decoupled from the link second loop 98 and the winch cable 104 can be completely retracted by the vehicle-mounted winch assembly 102.

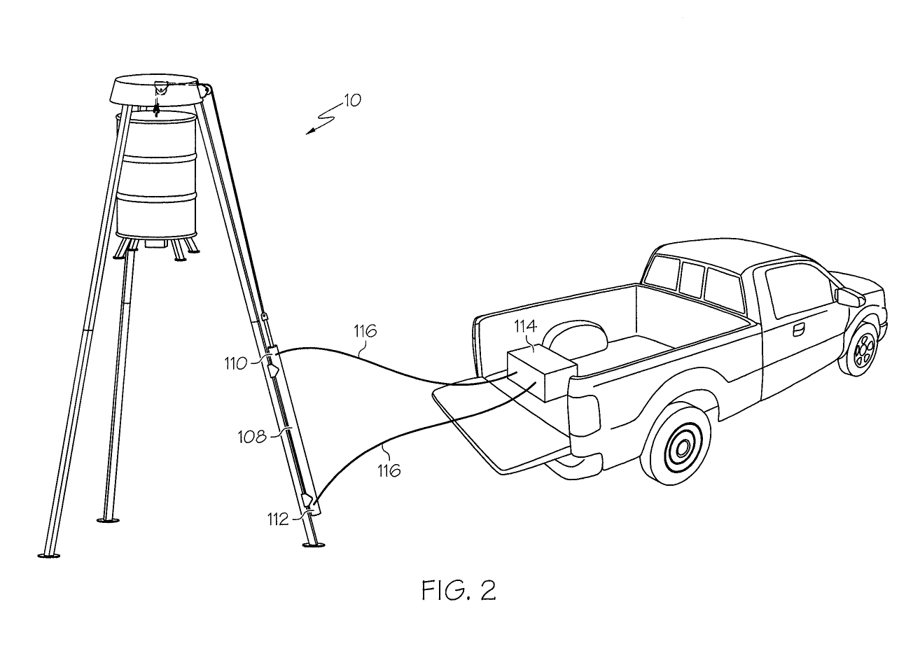

FIG. 2 shows an embodiment of the invention wherein a linear actuator 108 having a first end 110 and a second end 112 is utilized to raise and lower the animal feeder assembly 46. The linear actuator is mounted to one of the leg lower sections 18 between its first end 24 and second end 26. In the embodiment shown in FIG. 2, a second pulley 90 is mounted to the stand 12 proximate one of the leg upper section first ends 20. The cable first end 84 is suspended from a pulley 88 and is secured to the hanger 76 that is affixed to the container 48 at its top portion 50. Again, it will be appreciated by one skilled in the art that the hanger 76 can also be affixed to the container 48 at its sidewall 62 or its bottom portion 56. The cable second end 86 is secured to the linear actuator first end 110. It will be appreciated by one skilled in the art that the linear actuator can be an electric linear actuator, a hydraulic linear actuator, or a pneumatic linear actuator.

The embodiment shown in FIG. 2 also includes a vehicle-mounted apparatus 114 for actuating the linear actuator 108. The displacement of the linear actuator 108 is controlled by this vehicle-mounted apparatus 114. Based on the type of linear actuator 108 implemented, the vehicle-mounted apparatus 114 may be selected from a group consisting of a battery, an electric generator, a hydraulic pump, an air compressor, a compressed air reservoir, and combinations thereof.

When a user desires to lower the animal feeder assembly 46 in the embodiment shown in FIG. 2, the user first connects the linear actuator 108 to the vehicle-mounted apparatus 114 via a connection means 116. Once connected, the user activates the vehicle-mounted apparatus 114 such that the linear actuator 108 is lengthened. In a preferred embodiment, the linear actuator 108 has a stroke long enough to allow the animal feeder assembly 46 to travel from its fully raised position to its fully lowered position. When the user desires to raise the animal feeder assembly 46, the user activates the vehicle-mounted apparatus 114 such that the linear actuator 108 is shortened. After the animal feeder assembly 46 is in its desired raised position, the user them disconnects the linear actuator 108 from the vehicle-mounted apparatus 114.

From the foregoing, it may be seen that the animal feeder apparatus of the present invention is particularly well suited for the proposed usages thereof. Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

We claim:

1. An animal feeder apparatus comprising:
a stand including at least three legs, and a top portion;
an animal feeder assembly including a container, at least two support legs extending downwardly from a bottom surface of said container, a hanger configured for suspending said container from said stand top portion, and a feed dispensing assembly;
an animal feeder suspension assembly including a cable having a first end and a second end, and at least one pulley; and
a vehicle-mounted winch assembly.

2. The apparatus of claim 1, said stand legs comprising an upper section, a lower section, and a means for joining said upper sections and said lower sections.

3. The apparatus of claim 1 wherein said hanger is affixed to said container at a top surface of said container.

4. The apparatus of claim 1 wherein said cable first end is secured to said hanger.

5. The apparatus of claim 1 further comprising a dowel protruding from one of said stand legs and a link having a first loop and a second loop, said link first loop secured to said cable second end.

6. The apparatus of claim 5 wherein said link second loop is configured for coupling with said dowel for retaining said animal feeder assembly in a raised position.

7. An animal feeder apparatus comprising:
a stand including at least three legs, and a top portion;
an animal feeder assembly including a container, at least two support legs extending downwardly from a bottom surface of said container, a hanger configured for suspending said container from said stand top portion, and a feed dispensing assembly;
an animal feeder suspension assembly including a cable having a first end and a second end, and at least one pulley; and
a linear actuator having a first end and a second end; and
a vehicle-mounted means for actuating said linear actuator.

8. The apparatus of claim 7, said stand legs comprising an upper section, a lower section, and a means for joining said upper sections and said lower sections.

9. The apparatus of claim 7 wherein said hanger is affixed to said container at a top surface of said container.

10. The apparatus of claim 7 wherein said cable first end is secured to said hanger.

11. The apparatus of claim 7 wherein said linear actuator is mounted to one of said stand legs and said cable second end is secured to said linear actuator first end.

12. The apparatus of claim 7 wherein said linear actuator has a stroke length sufficient to lower said animal feeder assembly from a raised position to ground level.

13. The apparatus of claim 7 wherein said linear actuator is an electric linear actuator.

14. The apparatus of claim 13 wherein said electric linear actuator is connected to an electrical power supply located about a vehicle.

15. The apparatus of claim 13 wherein said electric linear actuator is connected to a vehicle electrical power supply.

16. The apparatus of claim 7 wherein said linear actuator is a hydraulic linear actuator.

17. The apparatus of claim 16 wherein said hydraulic linear actuator is connected to a hydraulic pump located about a vehicle.

18. The apparatus of claim 7 wherein said linear actuator is a pneumatic linear actuator.

19. The apparatus of claim 18 wherein said pneumatic linear actuator is connected to an air supply located about a vehicle.

20. An animal feeder apparatus comprising:
means for coupling a vehicle-mounted winch assembly to an animal feeder suspension assembly;
means for coupling said animal feeder suspension assembly to an animal feeder assembly;
means for raising and lowering said animal feeder assembly by actuating said vehicle-mounted winch assembly;
means for retaining said animal feeder assembly in a raised position; and
means for dispersing animal feed.
